(19) United States
(12) Patent Application Publication
(10) Pub. No.: US 2026/0046040 A1
(43) Pub. Date: Feb. 12, 2026

(54) USER TERMINAL CROSS POLARIZATION ALIGNMENT AND POWER ADJUSTMENT

(71) Applicant: Kratos Integral Holdings LLC, San Diego, CA (US)

(72) Inventors: Paul Isaac, San Jose, CA (US); Camille Chomel, Toulouse (FR)

(21) Appl. No.: 18/795,911

(22) Filed: Aug. 6, 2024

(51) Int. Cl. H04B 17/12; H04B 17/10; H04B 17/20

(52) U.S. Cl. CPC H04B 17/12; H04B 17/102; H04B 17/202

(57) ABSTRACT

Described herein are systems, methods, and other techniques for aligning a terminal in a satellite communication system. An indicator of a test slot is sent to the terminal to designate a specific frequency allocation for testing. The satellite obtains a set of multi-slot power measurements based on signals received, including a first signal transmitted by the terminal on the test slot. The measurements are transmitted by the satellite to a ground station in a second signal. A set of power measurements specifically for the test slot are extracted from the multi-slot power measurements. The extracted power measurements are transmitted by a gateway to the satellite in a third signal and then from the satellite to the terminal in a fourth signal. These power measurements are utilized by the terminal to perform pointing and cross polarization alignment and power adjustment.

### BACKGROUND OF THE INVENTION

Satellite communication systems play a crucial role in facilitating global connectivity across diverse applications, including telecommunications, broadcasting, internet services, and remote sensing. These systems operate by transmitting signals between ground-based Earth stations and satellites in orbit. The efficiency and reliability of such systems are important to addressing the increasing demands of contemporary communication and data services. Presently, communications engineers encounter numerous challenges, with a key concern being the optimization of information transmission over limited resources. Given the scarcity of available frequencies for radio signal communication and the rapid growth in the volume of information to be conveyed, there is a need to maximize the efficiency of available frequencies through the use of new hardware and software solutions at the ground stations, terminals, and satellites that make up such communication systems.

### SUMMARY OF THE INVENTION

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is a method of performing an alignment of a terminal in a satellite communication system, the method comprising: sending an indicator of a test slot to the terminal; obtaining, by a satellite, a set of multi-slot power measurements based on signals received at the satellite, the signals including a first signal transmitted by the terminal on the test slot; transmitting, by the satellite, a second signal including the set of multi-slot power measurements to a ground station; extracting a set of power measurements for the test slot from the set of multi-slot power measurements included in the second signal; transmitting, by a gateway, a third signal including the set of power measurements for the test slot to the satellite; and transmitting, by the satellite, a fourth signal including the set of power measurements for the test slot to the terminal, the set of power measurements for the test slot to be used for performing the alignment of the terminal.

Example 2 is the method of example(s) 1, wherein performing the alignment of the terminal includes one or both of performing a cross polarization alignment or a pointing alignment of the terminal.

Example 3 is the method of example(s) 1-2, wherein the set of power measurements for the test slot include a first set of power measurements for a first polarization and a second set of power measurements for a second polarization.

Example 4 is the method of example(s) 3, wherein the first polarization is a first linear polarization and the second polarization is a second linear polarization that is orthogonal to the first linear polarization.

Example 5 is the method of example(s) 3, wherein the first polarization is a first circular polarization and the second polarization is a second circular polarization.

Example 6 is the method of example(s) 1-5, wherein the set of power measurements for the test slot are extracted from the set of multi-slot power measurements based on a payload model of the satellite.

Example 7 is the method of example(s) 1-6, wherein the third signal and the fourth signal are transmitted via a management channel.

Example 8 is the method of example(s) 1-7, wherein the second signal is transmitted via a telemetry (TLM) link.

Example 9 is the method of example(s) 1-8, further comprising: prior to the terminal transmitting the first signal to the satellite on the test slot, performing a coarse pointing alignment of the terminal.

Example 10 is the method of example(s) 1-9, further comprising: transmitting, by the terminal, the first signal to the satellite on the test slot.

Example 11 is the method of example(s) 1-10, further comprising: performing the alignment of the terminal using the set of power measurements for the test slot.

Example 12 is a satellite communication system comprising: a satellite configured to: obtain a set of multi-slot power measurements based on signals received at the satellite, the signals including a first signal transmitted by a terminal on a test slot; and transmit a second signal including the set of multi-slot power measurements to a ground station; a correlator configured to extract a set of power measurements for the test slot from the set of multi-slot power measurements included in the second signal; and a gateway configured to transmit a third signal including the set of power measurements for the test slot to the satellite; wherein the satellite is configured to transmit a fourth signal including the set of power measurements for the test slot to the terminal, the set of power measurements for the test slot to be used for performing an alignment of the terminal.

Example 13 is the satellite communication system of example(s) 12, wherein performing the alignment of the terminal includes one or both of performing a cross polarization alignment or a pointing alignment of the terminal.

Example 14 is the satellite communication system of example(s) 12-13, wherein the set of power measurements for the test slot include a first set of power measurements for a first polarization and a second set of power measurements for a second polarization.

Example 15 is the satellite communication system of example(s) 14, wherein: the first polarization is a first linear polarization and the second polarization is a second linear polarization that is orthogonal to the first linear polarization; or wherein the first polarization is a first circular polarization and the second polarization is a second circular polarization.

Example 16 is the satellite communication system of example(s) 12, wherein the set of power measurements for the test slot are extracted from the set of multi-slot power measurements based on a payload model of the satellite.

Example 17 is the satellite communication system of example(s) 12, wherein the third signal and the fourth signal are transmitted via a management channel.

Example 18 is one or more non-transitory computer-readable media comprising instructions that, when executed by one or more processors, cause the one or more processors to perform operations for an alignment of a terminal in a satellite communication system, the operations comprising: sending an indicator of a test slot to the terminal; obtaining a set of multi-slot power measurements based on signals received at the satellite, the signals including a first signal transmitted by the terminal on the test slot; causing the satellite to transmit a second signal including the set of multi-slot power measurements to a ground station; extracting a set of power measurements for the test slot from the set of multi-slot power measurements included in the second signal; causing a gateway to transmit a third signal including the set of power measurements for the test slot to the satellite; and causing the satellite to transmit a fourth signal including the set of power measurements for the test slot to the terminal, the set of power measurements for the test slot to be used for performing the alignment of the terminal.

Example 19 is the one or more non-transitory computer-readable media of example(s) 18, wherein performing the alignment of the terminal includes one or both of performing a cross polarization alignment or a pointing alignment of the terminal.

Example 20 is the one or more non-transitory computer-readable media of example(s) 18-19, wherein the set of power measurements for the test slot include a first set of power measurements for a first polarization and a second set of power measurements for a second polarization.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example satellite communication system that enables alignment and power adjustment of a terminal connecting to a satellite.

FIG. 2 illustrates test slot power measurements and alignment indicators that may be displayed at a terminal.

FIG. 3 illustrates an example method of performing an alignment of a terminal in a satellite communication system.

FIG. 4 illustrates an example communication path between end points enabled by a satellite communication system.

FIG. 5 illustrates an example satellite communication system including a gateway and a set of terminals.

FIG. 6 illustrates an example method of performing an alignment of a terminal in a satellite communication system.

FIG. 7 illustrates an example computer system comprising various hardware elements.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

In a satellite communication system, a user terminal is a ground-based equipment that communicates directly with a satellite. User terminals can send and receive data, voice, and video signals to and from the satellite, enabling various applications such as internet access, television broadcasting, and remote sensing. The satellite communication system can support multiple user terminals. For example, modern satellites equipped with digital transparent processors (DTP) can dynamically allocate bandwidth and routes for different user terminals. This flexibility allows the satellite to manage and prioritize traffic from multiple user terminals.

The process of connecting a user terminal to a satellite communication system can involve several steps to ensure optimal performance and avoid interference with other satellites. User terminals when accessing the satellite may need to be verified for fine pointing, cross polarization alignment, and power in order to ensure they are correctly pointed and do not impact adjacent satellites. Fine pointing alignment ensures that user terminals are accurately pointed towards the satellite to achieve a strong and stable connection. This can involve adjusting the azimuth (horizontal angle) and elevation (vertical angle) of the terminal's antenna to precisely target the satellite's location in the sky. Cross polarization alignment ensures that the orthogonal polarization (e.g., horizontal and vertical) used by the satellite to increase its bandwidth efficiency matches the user terminal's polarization. Power level adjustment ensures that the user terminal is transmitting at the correct power level. Transmitting at too high a power can cause interference with adjacent satellites and saturation at the user terminal equipment, while too low a power can result in weak signals.

The conventional approach for verifying a user terminal for fine pointing, cross polarization alignment, and power is to use ground-based equipment at the gateway to monitor and verify that the user terminal is transmitting at the correct power and polarization. Such techniques rely on a network operation center and do not provide direct feedback to the installer of the terminal. Furthermore, such techniques do not utilize measurements made at the satellite and instead rely on ground-based measurements that are extrapolated to estimate the real power seen at the satellite.

The present invention provides a method and system for terminal alignment and power validation using satellite-obtained power measurements relayed in telemetry to spacecraft control centers (SCC). The system leverages digital transparent processors (DTP) on satellites, which route specific frequencies from input to output, forming channels that connect gateways to user beams and vice versa. These channels consist of elementary bandwidths (EB) typically ranging from 1.5 to 2.0 MHz, depending on the payload bus manufacturer. In some examples, the invention utilizes a configuration file, or payload model, to represent the DTP configuration and the satellite's path, detailing connectivity, EB allocation, and frequencies used. The satellite bus provides integrated power measurements for the EB and offers fine mode measurements for fractions of the EB, typically less than 50 kHz. By employing these fine mode measurements, the invention can distinguish power within the EB and align it with specific user terminals accessing defined slots in continuous wave (CW) mode. This enhances the accuracy of terminal alignment and power validation, improving the efficiency and reliability of satellite communication systems.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

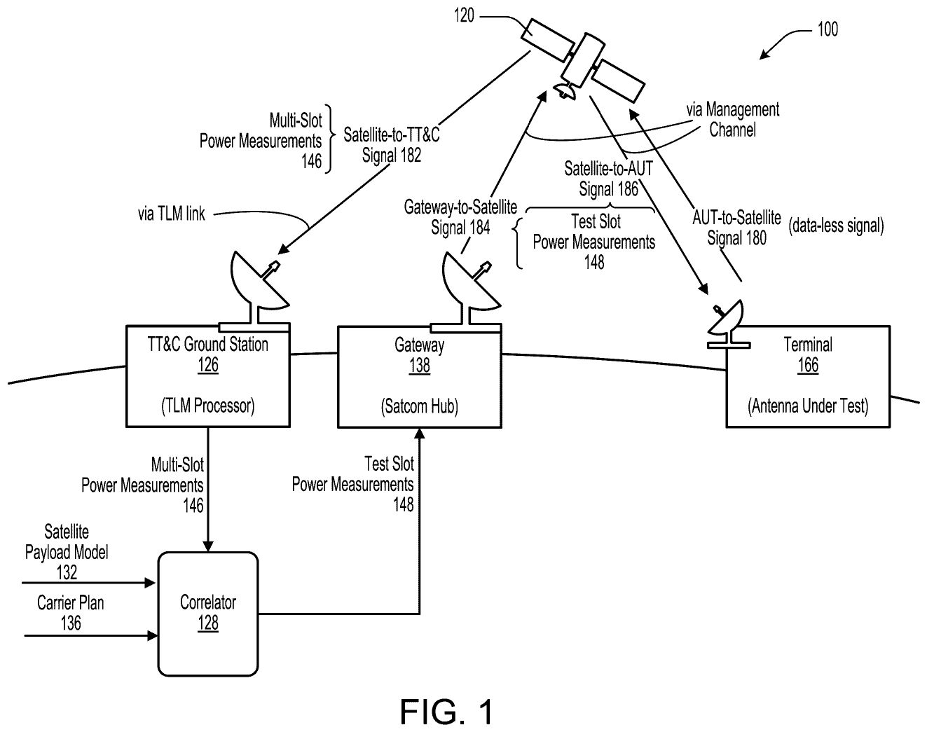

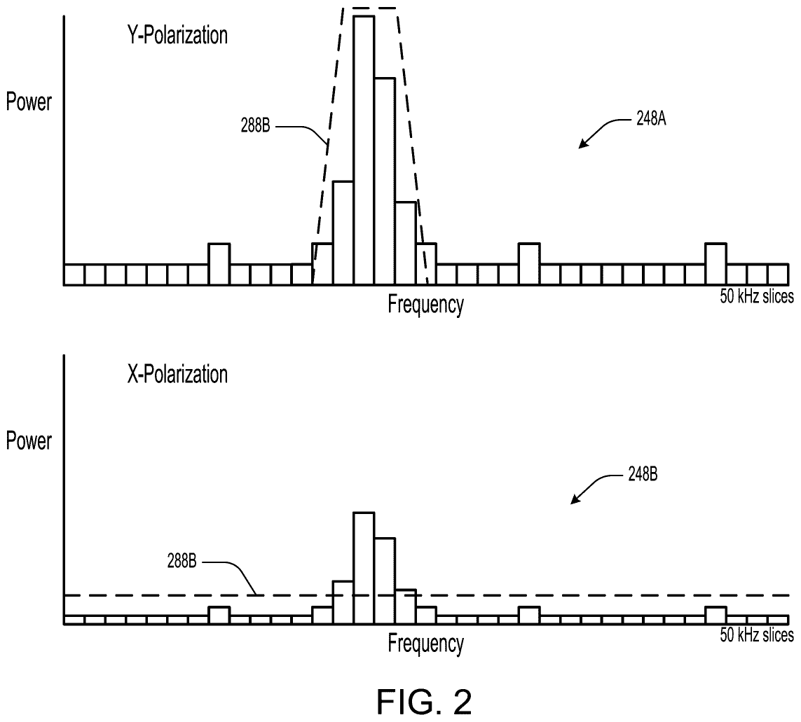

The figures herein follow a numbering convention in which the first digit or digits correspond to the figure number and the remaining digits identify an element or component in the figure. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates an example satellite communication system 100 that enables alignment and power adjustment of a terminal 166 connecting to a satellite 120, in accordance with some embodiments of the present disclosure. Terminal 166 may include an antenna, alternatively referred to as an antenna under test (AUT), that may transmit wireless signals to satellite 120 on a test slot of satellite 120 and receive wireless signals from satellite 120 via a management channel. The test slot may be a frequency allocation used to verify terminal 166 for fine pointing, cross polarization alignment, and power. The frequency allocation of the test slot may be a fraction of an EB, such as less than or equal to 50 kHz.

In the illustrated example, satellite communication system 100 includes a gateway 138, a telemetry, tracking, and command (TT&C) ground station 126, and a correlator 128. In some examples, gateway 138 may act as a hub that connects the satellite network to terrestrial networks (such as the internet, private networks, or public switched telephone networks). Gateway 138 may convert signals between the format used for satellite communication (typically radio frequency (RF) signals) and the format used for terrestrial networks (such as digital data) and perform traffic management functions by directing data to the appropriate destination, whether it is another satellite terminal or a terrestrial network. TT&C ground station 126 may be specifically dedicated to the monitoring, control, and management of satellite 120. TT&C ground station 126 may gather telemetry data from satellite 120 and send this data to correlator 128 and/or gateway 138 for analysis and decision-making.

During an alignment or power adjustment process, gateway 138 may send an identifier or an indicator of an available test slot to terminal 166 on which it may transmit a data-less signal. In response, an installer may optionally perform a coarse adjustment of the antenna of terminal 166 to orient the antenna toward satellite 120, and terminal 166 may begin transmitting an AUT-to-satellite signal 180 (alternatively referred to herein as a first signal or a first wireless signal) to satellite 120 on the test slot. Upon receiving AUT-to-satellite signal 180, satellite 120 may generate a set of power measurements based on the signal received on the test slot. The set of power measurements may be included in multi-slot power measurements 146, which may also include power measurements made for other signals received from other user terminals on other test slots and/or other transmissions through satellite 120.

Satellite 120 may employ various methods to measure the power of received signals from user terminals. One method involves using broadband power detectors to measure the total power received across a broad frequency range, providing integrated power measurements of the entire signal bandwidth. In some examples, satellite 120 may be equipped with DTPs that can monitor the power within specific EBs, typically ranging from 1.5 to 2.0 MHz, allowing for more granular monitoring of signal power. Fine mode measurements further enhance this capability by measuring power within fractional segments of the EB, often with a resolution finer than 50 kHz. In some examples, terminal 166 may transmit AUT-to-satellite signal 180 in continuous wave (CW) mode as an unmodulated carrier wave, and satellite 120 may generate peak, average, and/or RMS power readings of the CW signal at 50 kHz intervals across one or more EBs.

Satellite 120 may encode multi-slot power measurements 146 into a satellite-to-TT&C signal 182 (alternatively referred to herein as a second signal or a second wireless signal) and transmit the signal to TT&C ground station 126 via a telemetry (TLM) link. In some examples, TT&C ground station 126 may optionally process multi-slot power measurements 146 by, for example, removing noise and outliers and applying filtering techniques such as moving average filters or Kalman filters to smooth the data. In some examples, the power measurements may optionally be normalized to a common scale to facilitate comparison and analysis. This can involve converting power levels to decibels (dB) or standardizing the data range.

TT&C ground station 126 may route multi-slot power measurements 146 to correlator 128 to further process the data. In some examples, correlator 128 may correlate multi-slot power measurements 146 with a satellite payload model 132 and a carrier plan 136 to extract test slot power measurements 148 from multi-slot power measurements 146. Satellite payload model 132 may include details of the satellite's payload configuration, including a description the various components of satellite 120 and their interconnections. Satellite payload model 132 may include details about transponders, such as their frequency allocations, bandwidth capacities, and power levels, as well as the organization and routing of communication channels from uplink to downlink. It may also outline the types and locations of antennas, their beam patterns, and coverage areas. In some examples, satellite payload model 132 incorporates the configuration of DTPs, detailing how signals are routed, the allocation of EBs, and power measurement mechanisms. Carrier plan 136 may detail the specific frequency ranges assigned to various communication channels as well as the modulation schemes, data rates, and power levels for each carrier. In some examples, carrier plan 136 may indicate the start and stop frequencies of the test slot on which terminal 166 transmits AUT-to-satellite signal 180.

Correlator 128 may send test slot power measurements 148 to gateway 138, which may act as a satcom hub. With gateway 138 having the power measurements, it understands which user terminal is accessing which test slot and it can send the power measurements over the management channel to the user terminal trying to access satellite communication system 100. In the illustrated example, gateway 138 may encode test slot power measurements 148 into a gateway-to-satellite signal 184 (alternatively referred to herein as a third signal or a third wireless signal) and transmit the signal to satellite 120 via the management channel. Satellite 120 may receive gateway-to-satellite signal 184, optionally decode test slot power measurements 148 from gateway-to-satellite signal 184, optionally encode test slot power measurements 148 into a satellite-to-AUT signal 186 (alternatively referred to herein as a fourth signal or a fourth wireless signal) and transmit the signal to terminal 166 via the management channel. In some examples, gateway-to-satellite signal 184 is routed through satellite 120 to form satellite-to-AUT signal 186. In some examples, test slot power measurements 148 may be included in the management channel information contained in gateway-to-satellite signal 184 and satellite-to-AUT signal 186.

Test slot power measurements 148 are used by terminal 166 to perform alignment and/or power adjustment at terminal 166. In some examples, test slot power measurements 148 may be displayed on a display device at terminal 166. In some examples, an installer of terminal 166 may adjust the antenna based on test slot power measurements 148. For example, to perform polarization alignment, the installer may rotate or orient the antenna to increase or decrease a first portion of test slot power measurements 148 corresponding to a first polarization and/or increase or decrease a second portion of test slot power measurements 148 corresponding to a second polarization. In some examples, a processor at terminal 166 may cause automatic adjustment to the antenna based on test slot power measurements 148.

FIG. 2 illustrates test slot power measurements 248 along with alignment indicators 288 that may be displayed and/or analyzed at a terminal, in accordance with some embodiments of the present disclosure. Test slot power measurements 248A may correspond to power measurements made for a first polarization (e.g., y-polarization) and test slot power measurements 248B may correspond to power measurements made for a second polarization (e.g., y-polarization) that is orthogonal to the first polarization. In the illustrated example, the test slot has a frequency bandwidth of 1.75 MHz with power measurements made for each 50 kHz slice of the 1.75 MHz bandwidth (i.e., 35 power measurements for each polarization). By comparing test slot power measurements 248 to their corresponding alignment indicators 288, an installer or a processor of the user terminal may adjust the antenna until test slot power measurements 248A fit under alignment indicator 288A and test slot power measurements 248B fit under alignment indicator 288B.

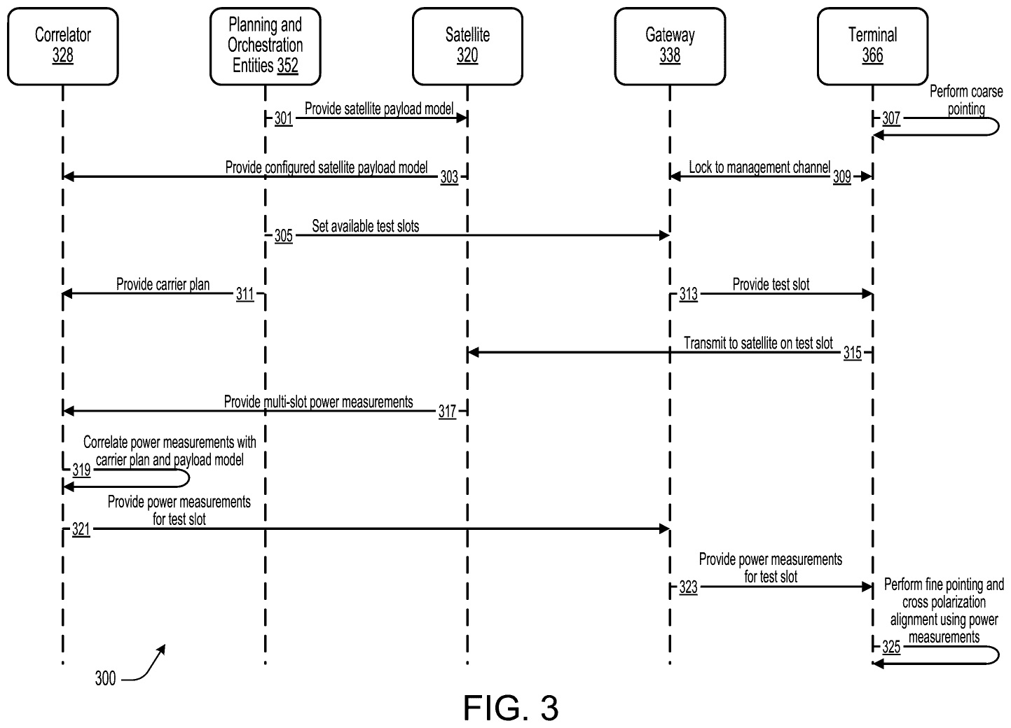

FIG. 3 illustrates an example method 300 of performing an alignment of a terminal 366 in a satellite communication system, in accordance with some embodiments of the present disclosure. Steps of method 300 may be performed in any order and/or in parallel, and one or more steps of method 300 may be optionally performed. One or more steps of method 300 may be performed by one or more processors. Method 300 may be implemented as a computer-readable medium or computer program product comprising instructions which, when the program is executed by one or more processors, cause the one or more processors to carry out the steps of method 300.

At step 301, one or more planning and orchestration entities 352 provide a satellite payload model to a satellite 320. Satellite 320 may configure itself in accordance with the satellite payload model. In various examples, the functionality of planning and orchestration entities 352 may be performed at a gateway 338, a ground station, or other entity of the satellite communication system.

At step 303, satellite 320 provides the configured satellite payload model to a correlator 328.

At step 305, planning and orchestration entities 352 set one or more test slots as being available for transmission and communicate these available test slots to gateway 338.

At step 307, coarse pointing of terminal 366 is performed by manual or automatic adjustment of the terminal's antenna.

At step 309, gateway 338 and terminal 366 lock to a management channel to enable communication between gateway 338 and terminal 366 via the management channel.

At step 311, planning and orchestration entities 352 provide a carrier plan to correlator 328.

At step 313, gateway 338 selects a test slot from the available test slot and provides an indicator of the selected test slot to terminal 366.

At step 315, terminal 366 transmits to satellite 320 on the test slot.

At step 317, satellite 320 generates multi-slot power measurements based on signals received at satellite 320 and provides the obtained measurements to correlator 328.

At step 319, correlator 328 correlates the multi-slot power measurements with the carrier plan and/or the payload model to extract power measurements for the test slot.

At step 321, correlator 328 provides the power measurements for the test slot to gateway 338.

At step 323, gateway 338 provides the power measurements for the test slot to terminal 366 via the management channel (e.g., via satellite 320).

At step 325, fine pointing and/or cross polarization alignment of terminal 366 is performed using the power measurements for the test slot by manual or automatic adjustment of the terminal's antenna. Alternatively or additionally, power adjustment of terminal 366 may be performed using the power measurements for the test slot by manual or automatic adjustment of the terminal's antenna

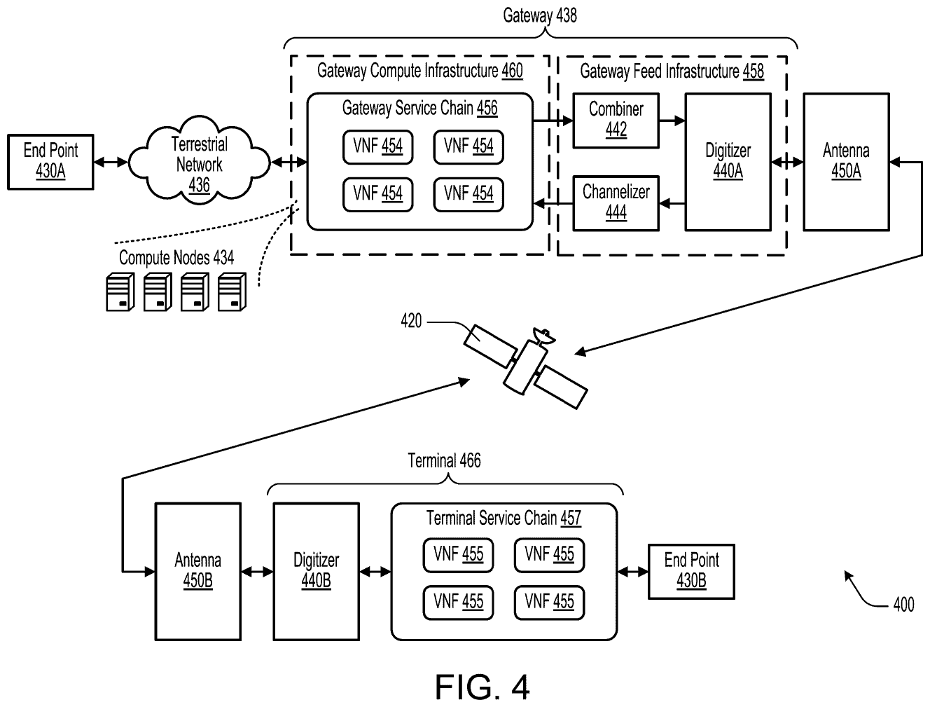

FIG. 4 illustrates an example communication path between an end point 430A and an end point 430B enabled by a satellite communication system 400, in accordance with some embodiments of the present disclosure. In the illustrated example, satellite communication system 400 includes a gateway 438 in communication with a terminal 466 via a satellite 420. In various examples, satellite 420 may send and receive wireless signals within one or more bands of a number of possible frequency bands between 1-300 GHz including, for example, 1 GHz and 300 GHz, including L Band (1-2 GHz), C-Band (4-8 GHz), X-Band (8-12 GHz), Ku-Band (12-18 GHz), Ka-Band (26.5-40 GHz), S-Band (2-4 GHz), and V-Band (40-75 GHz).

In various examples, end points 430 may correspond to portable mobile devices, internet of things (IoT) devices, desktop computers, user terminals, or any of a number of devices with communication capabilities. Alternatively, end points 430 may correspond to networks such as mobile towers, mining sites, ships, planes, or the like. In one example, end point 430A may correspond to a service and end point 430B may correspond to a consumer. It should be understood that the satellite communication environment may comprise other end points 410 and/or other arrangements of components than those illustrated. Furthermore, multiple communication paths may be constructed and operated in parallel, and separate communication paths may have different arrangements from each other.

End point 430A may be communicatively connected via a terrestrial network 436 (e.g., comprising the Internet, a private telecom backbone, or a cloud compute center) to a gateway 438. Gateway 438 may include one or more switches (not shown) to facilitate communication between the various components, such as a first switch at the boundary between terrestrial network 436 and a gateway compute infrastructure 460, and a second switch at the boundary between gateway compute infrastructure 460 and a gateway feed infrastructure 458. Such switches may be physical or virtual Gigabit Ethernet (GigE) switches. However, it should be understood that the above-described first and second switches could be implemented in the same switch. In some examples, the first switch may implement transport from terrestrial network 436 to a VNF 454 within a gateway service chain 456. In such a case, VNF 454 may act as a User Network Interface (UNI) or an External Network-Network Interface (ENNI) as defined by the applicable MEF Ethernet services and MEF operator services standards. Alternatively, the first switch may itself represent the UNI as defined by the applicable MEF standards.

Gateway compute infrastructure 460 may include a set of compute nodes 434 situated onsite (at a same physical location) or offsite (at a different physical location) relative to antenna 450. In some examples, compute nodes 434 may comprise general-purpose computers or servers capable of running VNFs 454 (e.g., as workloads) and other virtualization software such as hypervisors to support gateway service chain 456. In some examples, compute nodes 434 may employ x86 architectures, ARM architectures, RISC-V architectures, among other possibilities. Compute nodes 434 may be configured as clusters, data centers, warehouse-scale computers, among other possibilities. Gateway compute infrastructure 460 may further include suitable storage systems that provide persistent and reliable storage in support of VNFs 454.

In some examples, gateway compute infrastructure 460 may include a managing system that instantiates and configures one or more VNFs 454 to form gateway service chain 456. Two sets of one or more VNFs 454 may provide two-way communication, including a transmission path and a reception path, between terrestrial network 436 and a gateway feed infrastructure 458 of gateway 456. It should be understood that in an example in which gateway service chain 456 provides only one-way communication, VNFs 454 may provide only a transmission path without providing a reception path. The set of VNFs 454 (e.g., implementing a gateway) on the forward path towards the link to satellite 420, may comprise or constitute a traffic handler, an encapsulator (e.g., implementing generic stream encapsulation (GSE)), a modulator (e.g., the OpenSpace™ Wideband Software modulator, offered by Kratos Defense & Security Solutions, Inc. of San Diego, California), a combiner, an encryption/decryption VNF, a time division multiple access (TDMA) resource allocator, an antenna controller, among other possibilities.

This set of VNFs 454 on the transmission path may convert protocol data units (PDUs) into a digital signal (such as a digital intermediate frequency (IF) waveform or a composite digital IF waveform). For example, the traffic handler may process data link layer (e.g., Layer 2 or L2 in the Open Systems Interconnection (OSI) model) and/or network layer (e.g., Layer 3 or L3 in the OSI model) traffic, and provide the processed Ethernet frames or IP packets to the encapsulator. The encapsulator may convert the PDUs into baseband frames, and provide the baseband frames to the modulator. A baseband frame may be the basic unit of transmission in satellite communication system 400. The encapsulator may form baseband frames in accordance with the 5G standard, the DVB-S2x standard, described in European Telecommunications Standards Institute (ETSI) European Standard (EN) 302 307-1 v1.4.1 (2014-11), among other possible standards. The encapsulator may comprise one or more VNFs 454 (or software subprocesses) that perform one or more of the following functions: frame chopping, forward modulation selection (e.g., with Adaptive Coding and Modulation (ACM)), Ethernet bridge (e.g., Media Access Control (MAC) table, smart bridging/learning/relay, etc.), Address Resolution Protocol (ARP) (e.g., Ethernet MAC discovery), VLAN manipulation (e.g., to rewrite Ethernet frames on ingress/egress based on the MEF service definition), header compression (e.g., Robust Header Compression (ROHC)); and/or OTA optimization (e.g., Space Communications Protocol Specifications (SCPS)/TCP-Acceleration). The modulator may convert the baseband frames into signal data packets in accordance with a particular standard, including the standards of the Digital Intermediate Frequency Interoperability (DIFI) Consortium in the DIFI/Institute of Electrical and Electronics Engineers (IEEE) 1.0 specification, the VMEbus International Trade Association (VITA) standard, the enhanced Common Public Radio Interface (eCPRI) standard, among other possibilities. In an embodiment, the encapsulator and the traffic handler may be implemented as a single VNF 454, referred to as a virtualized traffic adaptor (vModem). The VNF-implemented combiner or a combiner 442 (implemented in hardware) may combine the signal data packets into a digital signal and provide the digital signal to a digitizer 440A, which may convert the digital signal into an analog signal.

The set of VNFs 454 on the return path may comprise or constitute, in order, a digital channelizer (e.g., the OpenSpace™ Wideband Channelizer, offered by Kratos Defense & Security Solutions, Inc. of San Diego, California), a demodulator (e.g., the OpenSpace™ Wideband Software Receiver, offered by Kratos Defense & Security Solutions, Inc. of San Diego, California), and a decapsulator. This set of VNFs 454 on the reception path may convert a digital signal (such as a digital IF waveform or a composite digital IF waveform) to PDUs, which may be Ethernet frames or IP packets, among other possibilities. For example, the VNF-implemented channelizer or a channelizer 444 (implemented in hardware) may receive a digital signal from digitizer 440A, which has converted an analog signal into the digital signal, and divide the digital signal into signal data packets. The demodulator may convert the signal data packets to baseband frames, and provide the baseband frames to the decapsulator. The decapsulator may convert the baseband frames into PDUs, which may be transmitted, via terrestrial network 436, to end point 430A. It should be understood that the demodulator performs the reverse function(s) of the modulator, and the decapsulator performs the reverse function(s) of the encapsulator. In an embodiment, the decapsulator and demodulator may be implemented as a single VNF 454, for example, together with the traffic handler, encapsulator, and modulator, in a vModem. In other words, a vModem may consist of a single VNF 454 that implements all of the functions of the traffic handler, encapsulator/decapsulator, and modulator/demodulator.

In some embodiments, in which gateway service chain 456 implements a vModem, the vModem may comprise one or more modulators that are configured to modulate waveforms according to a digital satellite broadcast standard and/or one or more demodulators that are configured to demodulate waveforms according to a digital satellite broadcast standard. Such a vModem may provide carrier ethernet (CE) services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames. The digital satellite broadcast standard may be a digital satellite television broadcast standard, such as the DVB-S2X standard managed by the Digital Video Broadcasting (DVB) Project. While a digital satellite broadcast standard, such as a DVB standard, is used as an example, the vModem may be configured to modulate and demodulate waveforms according to other standards for wideband digital communication, such as orthogonal frequency-division multiplexing (OFDM), or the like.

The digital signal from combiner 442 is transmitted to digitizer 440A, which converts the digital signal output by combiner 442 into an analog transmission signal for communication to satellite 420. Digitizer 440A further digitizes analog reception signals from satellite 420 into digital signals for use by channelizer 444. In some examples, digitizer 440A may be software-defined. As one example, digitizer 440A may be a SpectralNet™, which is a carrier-grade RF digitizer, offered by Kratos Defense & Security Solutions, Inc. of San Diego, California. Digitizer 440A communicates with antenna 450A. In particular, digitizer 440A provides the transmission signal to antenna 450A, which transmits the transmission signal to satellite 420. In addition, in two-way communications, antenna 450A receives a reception signal from satellite 420, and provides the reception signal to digitizer 440A.

In various examples, antenna 450A may be a parabolic reflector antenna, a flat panel antenna, a phased array antenna, a helical antenna, a patch antenna, a horn antenna, among other possibilities. In some examples, antenna 450A may be an electronically steered antenna that can use electronic means to control the direction and shape of its radiation pattern. Such an antenna can generate multiple beams simultaneously, allowing it to transmit or receive signals in multiple directions at the same time. Antenna 450A may include both the physical antenna as well as the corresponding radio frequency (RF) subsystem, which may include a combination of diplexers, amplifiers (e.g., low noise amplifiers (LNAs)), upconverters, and downconverters (e.g., low-noise block downconverters (LNBs) depending on the specific frequency band and application.

Satellite 420 relays wireless signals from antenna 450A to antenna 450B. In two-way communications, satellite 420 also relays wireless signals from antenna 450B to antenna 450A. Antenna 450B may be functionally similar or identical to antenna 450A, and therefore, any description of antenna 450A applies equally to antenna 450B, which may not be redundantly described herein. Similarly, digitizer 440B may be functionally similar or identical to digitizer 440A, and therefore, any description of digitizer 440A applies equally to digitizer 440B, which may not be redundantly described herein.

Digitizer 440B may communicate directly with a terminal service chain 457 of a terminal compute infrastructure. Terminal service chain 457 may comprise a set of VNF(s) 455 forming a reception path from digitizer 440B to end point 430B. In two-way communications, terminal service chain 457 may also comprise a set of VNFs 455 forming a transmission path from end point 430B to digitizer 440B. The reception and transmission paths may be identical or similar to the reception and transmission paths described with respect to gateway service chain 456. For example, the reception path may comprise a demodulator followed by a decapsulator to convert signal frames into PDUs, and the transmission path may comprise an encapsulator followed by a modulator to convert PDUs into signal frames. The traffic handler, encapslator, decapsulator, modulator, and demodulator may all be similar or identical to those described with respect to gateway service chain 456, and therefore, the descriptions of those components with respect to gateway service chain 456 apply equally to those components in terminal service chain 457.

Terminal service chain 457 may communicate with end point 430B. For example, the traffic handler of terminal service chain 457 may transmit Ethernet frames to end point 430B. In addition, in two-way communications, the encapsulator of terminal service chain 457 may receive PDUs from end point 430B. Thus, the combination of gateway service chain 456 and terminal service chain 457 enable one-way or two-way communications between end points 410A and 410B over a satellite link.

Gateway service chain 456 and terminal service chain 457 may comprise one or more of the software-defined components (e.g., VNFs and/or digitizers) described in International Patent App. Nos. PCT/US2021/033867, filed on May 24, 2021, PCT/US2021/033875, filed on May 24, 2021, PCT/US2021/033905, filed on May 24, 2021, and PCT/US2021/062689, filed on Dec. 9, 2021, which are all hereby incorporated herein by reference as if set forth in full.

Advantageously, the utilization of VNFs and software-defined components (e.g., digitizers 440A and 440B) to perform various functions, aid in automation and scalability. Embodiments may minimize the presence of physical hardware components, such that satellite communication system 400 can be dynamically reconfigured (e.g., added, updated, destroyed, increased or decreased in dimension, etc.) in real time, primarily using in-band network communications, to adapt to the unique multivariate satcom environment (e.g., changing traffic patterns, RF interference, atmospheric characteristics, antenna conditions, path length, etc.).

Notably, dynamic reconfiguration of VNFs in a cloud computing environment can be used, not only to increase the dimensions of the computing resources (e.g., number of vCPUs, amount of memory and/or disk storage, network throughput, etc.) used for satellite communication system 400 on demand to ensure the sufficiency of the satellite communication system, but also to decrease the dimensions of the computing resources on demand to optimize the utilization of the hardware. For example, favorable changes in the satcom environment may improve performance of satellite communication system 400, such that satellite communication system 400 is providing significantly better performance than is required by the service level agreement. In this case, the management system may determine that gateway service chain 456 and terminal service chain 457 are insufficient, and update the service chains to reduce the resources used in the service chains (e.g., by reducing RF bandwidth usage, resizing one or more VNFs, swapping to a service chain with reduced dimensions, etc.). This is in contrast to conventional hardware-based service chains in which unused resources would simply be idled or otherwise ignored, representing a sunk cost that cannot be recouped.

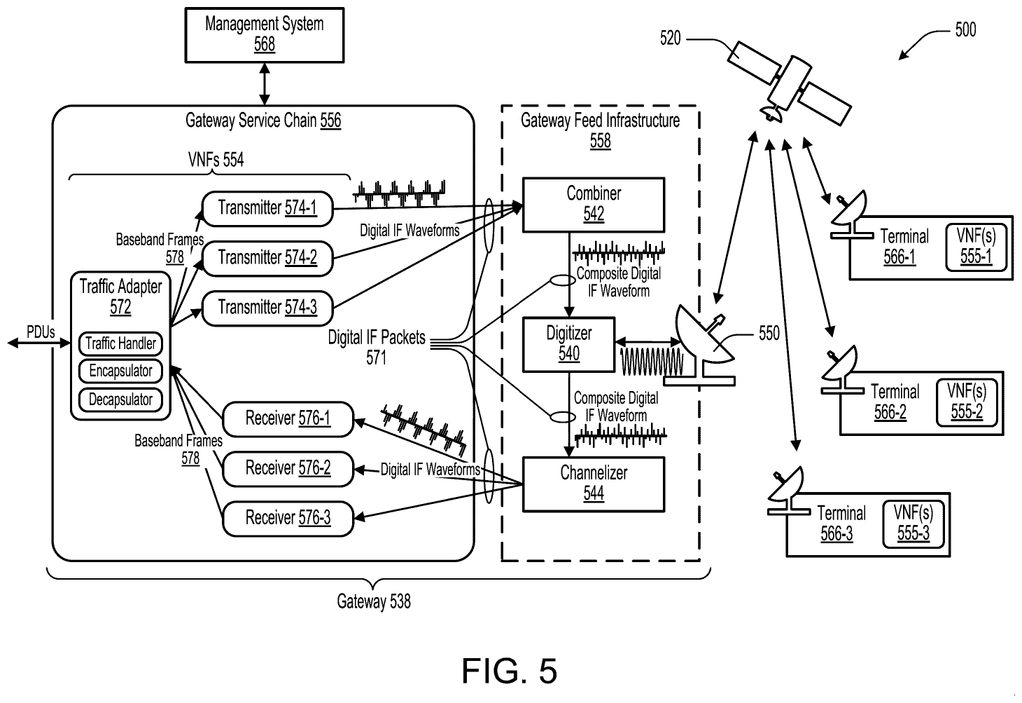

FIG. 5 illustrates an example satellite communication system 500 including a gateway 538 and a set of terminals 566 (or “remote terminals”), in accordance with some embodiments of the present disclosure. In the illustrated example, satellite communication system 500 includes a gateway 538 (or “hub”) in communication with each of terminals 566 via a satellite 520. Gateway 538 may include a gateway feed infrastructure 558 that serves as an onsite infrastructure (close to antenna 550, e.g., at a same physical location) that may perform primarily signal digitization and signal routing-related tasks and a gateway compute infrastructure that can be onsite or offsite infrastructure (far from antenna 550, e.g., at a different physical location) that supports a gateway service chain 556 that performs primarily signal processing and packet processing-related tasks. The gateway compute infrastructure may include one or more computers, clusters, a data center, or a warehouse-scale computer. The compute nodes comprising the gateway compute infrastructure and/or gateway feed infrastructure 558 may include general-purpose computers or servers employing x86 architectures, ARM architectures, RISC-V architectures, among other possibilities.

Gateway 538 may include a gateway service chain 556 comprising a set of VNFs 554 running on the gateway compute infrastructure. Example VNFs include one or more traffic adapters 572, one or more virtual transmitters 574, one or more virtual receivers 576, among other possibilities. Each of VNFs 554 may be instantiated and configured by a management system 568 that scales up or down the number of active VNFs based on the number of active terminals 566. Management system 568 may further configure VNFs 554 such that satellite communication system 500 implements any one of a number of network topologies, including a single channel per carrier (SCPC) network, a TDMA network, a frequency division multiple access (FDMA) network, a mesh network, among other possibilities.

VNFs 554 may include one or more virtual transmitters 574 that provide one or more transmission paths between a terrestrial network and a gateway feed infrastructure 558 of gateway 556. Each of the set of virtual transmitters 574 on a transmission path may comprise or constitute a modulator (e.g., the OpenSpace™ Wideband Software modulator) that converts incoming baseband frames 578 into digital IF packets 571 containing digital waveforms at IF or RF frequencies (or “digital IF waveforms”). Traffic adapter 572 acts as the bridge between the terrestrial network and the satellite network. In some examples, traffic adapter 572 may include a traffic handler that processes data link layer (e.g., Layer 2 in the OSI model) and/or network layer (e.g., Layer 3 in the OSI model) traffic and provides the processed PDUs to the encapsulator, which convert the PDUs into baseband frames 578 and provides baseband frames 578 to one of virtual transmitters 574. Each of virtual transmitters 574 may implement a modulator that converts baseband frames 578 into digital IF packets 571 (e.g., according to the standards of the DIFI Consortium in the DIFI/IEEE 1.2 specification) to create the digital IF waveforms.

Digital IF packets 571 generated by virtual transmitters 574 may be fed into a combiner 542 that combines the multiple digital IF waveforms into a single composite signal (or “composite digital IF waveform”). Digital IF packets 571 containing the composite digital IF waveform is fed into a digitizer 540 that converts the digital signal into an analog signal in preparation for wireless transmission via an antenna 550. While combiner 542 is illustrated in FIG. 5 as being an element of gateway feed infrastructure 558, it is to be understood that a combiner VNF (or multiple combiner VNFs) may be instantiated by management system 568 to perform similar functionality.

On the reception path, digitizer 540 digitizes analog signals received from satellite 520 to generate digital IF packets 571 containing digital IF waveforms (e.g., a composite digital IF waveform) of the received analog signals for use by a channelizer 544. The composite digital IF waveform received by channelizer 544 may be a wide-band spectrum (e.g., 100 MHz, 500 MHz, 300 GHz, etc.) that may contain several signals within that segment of the frequency band. In some instances, channelizer 544 divides the composite digital IF waveform into separate digital IF waveforms and sends the waveforms (in the form of digital IF packets 571) to appropriate virtual receivers 576. While channelizer 544 is illustrated in FIG. 5 as being an element of gateway feed infrastructure 558, it is to be understood that a channelizer VNF (or multiple channelizer VNFs) may be instantiated by management system 568 to perform similar functionality. VNFs 554 may include one or more virtual receivers 576 that provide one or more reception paths between gateway feed infrastructure 558 and a terrestrial network. Each of the set of virtual receivers 576 on a reception path may comprise or constitute a demodulator (e.g., the OpenSpace™ Wideband Software Receiver) that converts incoming digital IF packets 571 containing digital IF waveforms into baseband frames 578. In some examples, baseband frames 578 produced by virtual receivers are sent to the decapsulator of traffic adapter 572. The decapsulator may convert baseband frames 578 into Ethernet frames and pass the Ethernet frames to the traffic handler, which processes and provides the Ethernet frames to a terrestrial network.

Satellite 520 relays wireless signals from antenna 550 to the antennas of terminals 566, or vice versa. In two-way communications, satellite 520 also relays wireless signals from the antennas of terminals 566 to antenna 550. In some examples, each of terminals 566 may include hardware infrastructure to support one or more VNFs 555. In some examples, VNFs 555 at each of terminals 566 may implement a vModem that comprises one or more modulators that are configured to modulate waveforms according to a digital satellite broadcast standard and/or one or more demodulators that are configured to demodulate waveforms according to the digital satellite broadcast standard. Such a vModem may provide CE services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames, together with a traffic handler that connects the encapsulators and decapsulators with the terrestrial networks connected to terminals 566.

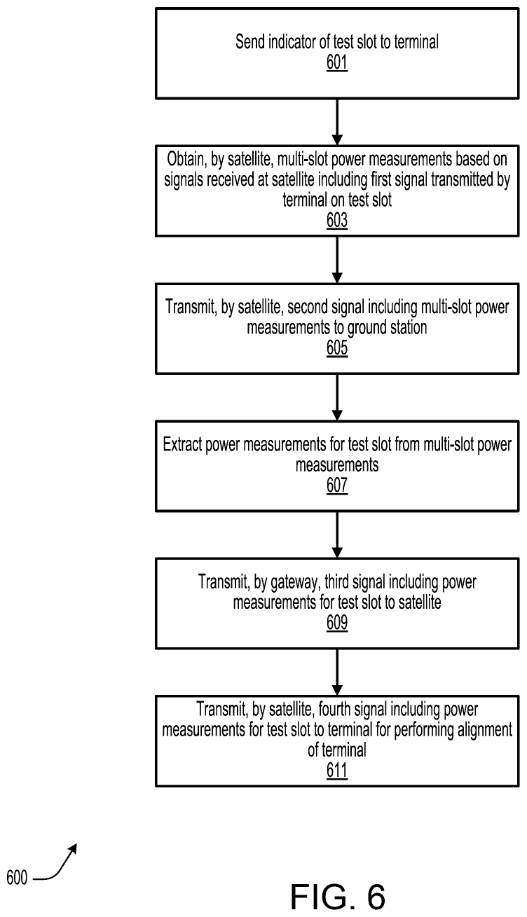

FIG. 6 illustrates an example method 600 of performing an alignment of a terminal in a satellite communication system (e.g., satellite communication systems 100, 400, 500), in accordance with some embodiments of the present disclosure. Steps of method 600 may be performed in any order and/or in parallel, and one or more steps of method 600 may be optionally performed. One or more steps of method 600 may be performed by one or more processors. Method 600 may be implemented as a computer-readable medium or computer program product comprising instructions which, when the program is executed by one or more processors, cause the one or more processors to carry out the steps of method 600.

At step 601, an indicator of a test slot is sent to a terminal (e.g., terminals 166, 366, 466, 566). The test slot may be one of a set of available test slots. The test slot may include a band of frequencies that comprise a fraction of an elementary bandwidth. The indicator may specify a start frequency and a stop frequency of the test slot.

At step 603, a satellite (e.g., satellites 120, 320, 420, 520) obtains a set of multi-slot power measurements (e.g., multi-slot power measurements 146) based on signals received at the satellite. The signals may include a first signal (e.g., AUT-to-satellite signal 180) transmitted by the terminal to the satellite on the test slot. The set of multi-slot power measurements may include power measurements for a first polarization and power measurements for a second polarization. The first polarization may be a first linear polarization and the second polarization may be a second linear polarization that is orthogonal to the first linear polarization. Alternatively, the first polarization may be a first circular polarization and the second polarization may be a second circular polarization.

At step 605, the satellite transmits a second signal (e.g., satellite-to-TT&C signal 182) including the set of multi-slot power measurements to a ground station (e.g., TT&C ground station 126). The second signal may be transmitted via a telemetry link.

At step 607, a set of power measurements for the test slot (e.g., test slot power measurements 148, 248) are extracted from the set of multi-slot power measurements included in the second signal. The set of power measurements for the test slot may be extracted based on a payload model (e.g., satellite payload model 132) of the satellite and/or a carrier plan (e.g., carrier plan 136). The set of power measurements for the test slot may be extracted by a correlator (e.g., correlator 128, 328).

At step 609, a gateway (e.g., gateways 138, 338, 438, 538) transmits a third signal (e.g., gateway-to-satellite signal 184) including the set of power measurements for the test slot to the satellite. The third signal may be transmitted via a management channel.

At step 611, the satellite transmits a fourth signal (e.g., satellite-to-AUT signal 186) including the set of power measurements for the test slot to the terminal. The fourth signal may be transmitted via the management channel. The set of power measurements for the test slot may be used for performing the alignment of the terminal, which may include one or both of performing a cross polarization alignment or a pointing alignment of the terminal. In some examples, the set of power measurements for the test slot may be used for adjusting a transmit power of the terminal.

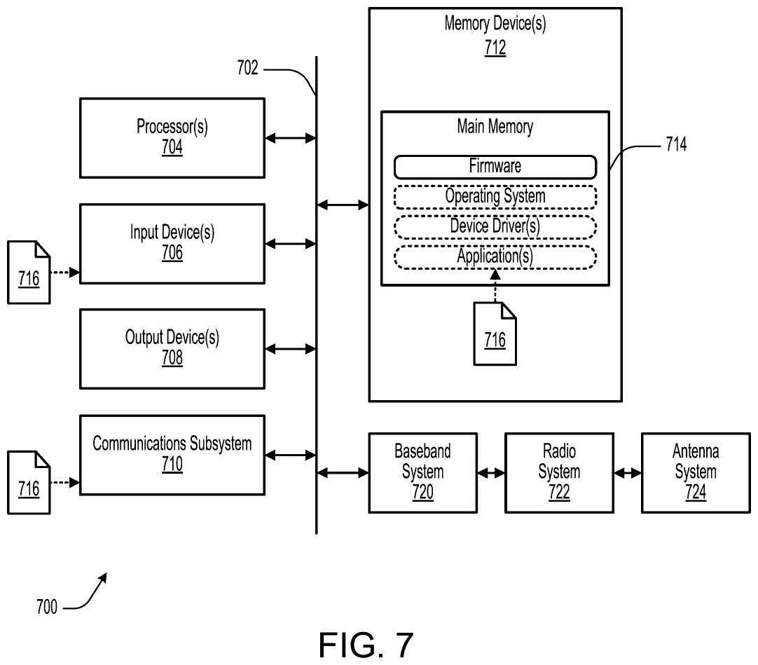

FIG. 7 illustrates an example computer system 700 comprising various hardware elements, in accordance with some embodiments of the present disclosure. Computer system 700 may be incorporated into or integrated with devices described herein and/or may be configured to perform some or all of the steps of the methods provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

In the illustrated example, computer system 700 includes a communication medium 702, one or more processor(s) 704, one or more input device(s) 706, one or more output device(s) 708, a communications subsystem 710, one or more memory device(s) 712, a baseband system 720, a radio system 722, and an antenna system 724. Computer system 700 may be implemented using various hardware implementations and embedded system technologies. For example, one or more elements of computer system 700 may be implemented within an integrated circuit (IC), an application-specific integrated circuit (ASIC), an application-specific standard product (ASSP), a field-programmable gate array (FPGA), such as those commercially available by XILINX®, INTEL®, or LATTICE SEMICONDUCTOR®, a system-on-a-chip (SoC), a microcontroller, a printed circuit board (PCB), and/or a hybrid device, such as an SoC FPGA, among other possibilities.

The various hardware elements of computer system 700 may be communicatively coupled via communication medium 702. While communication medium 702 is illustrated as a single connection for purposes of clarity, it should be understood that communication medium 702 may include various numbers and types of communication media for transferring data between hardware elements. For example, communication medium 702 may include one or more wires (e.g., conductive traces, paths, or leads on a PCB or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 702 may include one or more buses that connect the pins of the hardware elements of computer system 700. For example, communication medium 702 may include a bus that connects processor(s) 704 with main memory 714, referred to as a system bus, and a bus that connects main memory 714 with input device(s) 706 or output device(s) 708, referred to as an expansion bus. The system bus may itself consist of several buses, including an address bus, a data bus, and a control bus. The address bus may carry a memory address from processor(s) 704 to the address bus circuitry associated with main memory 714 in order for the data bus to access and carry the data contained at the memory address back to processor(s) 704. The control bus may carry commands from processor(s) 704 and return status signals from main memory 714. Each bus may include multiple wires for carrying multiple bits of information and each bus may support serial or parallel transmission of data.

Processor(s) 704 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 704 may include one or more multi-core processors, in which each core may read and execute program instructions concurrently with the other cores, increasing speed for programs that support multithreading.

Input device(s) 706 may include one or more of various user input devices such as a mouse, a keyboard, a microphone, as well as various sensor input devices, such as an image capture device, a temperature sensor (e.g., thermometer, thermocouple, thermistor), a pressure sensor (e.g., barometer, tactile sensor), a movement sensor (e.g., accelerometer, gyroscope, tilt sensor), a light sensor (e.g., photodiode, photodetector, charge-coupled device), and/or the like. Input device(s) 706 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 708 may include one or more of various devices that convert information into human-readable form, such as without limitation a display device, a speaker, a printer, a haptic or tactile device, and/or the like. Output device(s) 708 may also include devices for writing to removable storage devices or other removable media, such as those described in reference to input device(s) 706. Output device(s) 708 may also include various actuators for causing physical movement of one or more components. Such actuators may be hydraulic, pneumatic, electric, and may be controlled using control signals generated by computer system 700.

Communications subsystem 710 may include hardware components for connecting computer system 700 to systems or devices that are located external to computer system 700, such as over a computer network. In various embodiments, communications subsystem 710 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 712 may include the various data storage devices of computer system 700. For example, memory device(s) 712 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 704 and memory device(s) 712 are illustrated as being separate elements, it should be understood that processor(s) 704 may include varying levels of on-processor memory, such as processor registers and caches that may be utilized by a single processor or shared between multiple processors.

Memory device(s) 712 may include main memory 714, which may be directly accessible by processor(s) 704 via the address and data buses of communication medium 702. For example, processor(s) 704 may continuously read and execute instructions stored in main memory 714. As such, various software elements may be loaded into main memory 714 to be read and executed by processor(s) 704 as illustrated in FIG. 7. Typically, main memory 714 is volatile memory, which loses all data when power is turned off and accordingly needs power to preserve stored data. Main memory 714 may further include a small portion of non-volatile memory containing software (e.g., firmware, such as BIOS) that is used for reading other software stored in memory device(s) 712 into main memory 714. In some embodiments, the volatile memory of main memory 714 is implemented as RAM, such as dynamic random-access memory (DRAM), and the non-volatile memory of main memory 714 is implemented as read-only memory (ROM), such as flash memory, erasable programmable read-only memory (EPROM), or electrically erasable programmable read-only memory (EEPROM).

Computer system 700 may include software elements, shown as being currently located within main memory 714, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 716, which are executable by computer system 700. In one example, such instructions 716 may be received by computer system 700 using communications subsystem 710 (e.g., via a wireless or wired signal that carries instructions 716), carried by communication medium 702 to memory device(s) 712, stored within memory device(s) 712, read into main memory 714, and executed by processor(s) 704 to perform one or more steps of the described methods. In another example, instructions 716 may be received by computer system 700 using input device(s) 706 (e.g., via a reader for removable media), carried by communication medium 702 to memory device(s) 712, stored within memory device(s) 712, read into main memory 714, and executed by processor(s) 704 to perform one or more steps of the described methods.

Computer system 700 may include optional wireless communication components that facilitate wireless communication over a voice network and/or a data network. The wireless communication components comprise an antenna system 724, a radio system 722, and a baseband system 720. In computer system 700, RF signals are transmitted and received over the air by antenna system 724 under the management of radio system 722. In an embodiment, antenna system 724 may comprise one or more antennae and one or more multiplexors (not shown) that perform a switching function to provide antenna system 724 with transmit and receive signal paths. In the reception path, received RF signals can be coupled from a multiplexor to a low noise amplifier (not shown) that amplifies the received RF signal and sends the amplified signal to radio system 722. In an alternative embodiment, radio system 722 may comprise one or more radios that are configured to communicate over various frequencies. In an embodiment, radio system 722 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 722 to baseband system 720.

In some embodiments of the present disclosure, instructions 716 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 700. For example, the non-transitory computer-readable medium may be one of memory device(s) 712 (as shown in FIG. 7). In some cases, the non-transitory computer-readable medium may be separate from computer system 700. In one example, the non-transitory computer-readable medium may be a removable medium provided to input device(s) 706 (as shown in FIG. 7), such as those described in reference to input device(s) 706, with instructions 716 being read into computer system 700 by input device(s) 706. In another example, the non-transitory computer-readable medium may be a component of a remote electronic device, such as a mobile phone, that may wirelessly transmit a data signal that carries instructions 716 to computer system 700 and that is received by communications subsystem 710 (as shown in FIG. 7).

Instructions 716 may take any suitable form to be read and/or executed by computer system 700. For example, instructions 716 may be source code (written in a human-readable programming language such as Java, C, C++, C #, Python), object code, assembly language, machine code, microcode, executable code, and/or the like. In one example, instructions 716 are provided to computer system 700 in the form of source code, and a compiler is used to translate instructions 716 from source code to machine code, which may then be read into main memory 714 for execution by processor(s) 704. As another example, instructions 716 are provided to computer system 700 in the form of an executable file with machine code that may immediately be read into main memory 714 for execution by processor(s) 704. In various examples, instructions 716 may be provided to computer system 700 in encrypted or unencrypted form, compressed or uncompressed form, as an installation package or an initialization for a broader software deployment, among other possibilities.

In one aspect of the present disclosure, a system (e.g., computer system 700) is provided to perform methods in accordance with various embodiments of the present disclosure. For example, some embodiments may include a system comprising one or more processors (e.g., processor(s) 704) that are communicatively coupled to a non-transitory computer-readable medium (e.g., memory device(s) 712 or main memory 714). The non-transitory computer-readable medium may have instructions (e.g., instructions 716) stored therein that, when executed by the one or more processors, cause the one or more processors to perform the methods described in the various embodiments.

In another aspect of the present disclosure, a computer-program product that includes instructions (e.g., instructions 716) is provided to perform methods in accordance with various embodiments of the present disclosure. The computer-program product may be tangibly embodied in a non-transitory computer-readable medium (e.g., memory device(s) 712 or main memory 714). The instructions may be configured to cause one or more processors (e.g., processor(s) 704) to perform the methods described in the various embodiments.

In another aspect of the present disclosure, a non-transitory computer-readable medium (e.g., memory device(s) 712 or main memory 714) is provided. The non-transitory computer-readable medium may have instructions (e.g., instructions 716) stored therein that, when executed by one or more processors (e.g., processor(s) 704), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of performing an alignment of a terminal in a satellite communication system, the method comprising:
sending an indicator of a test slot to the terminal;
obtaining, by a satellite, a set of multi-slot power measurements based on signals received at the satellite, the signals including a first signal transmitted by the terminal on the test slot;
transmitting, by the satellite, a second signal including the set of multi-slot power measurements to a ground station;
extracting a set of power measurements for the test slot from the set of multi-slot power measurements included in the second signal;
transmitting, by a gateway, a third signal including the set of power measurements for the test slot to the satellite; and
transmitting, by the satellite, a fourth signal including the set of power measurements for the test slot to the terminal, the set of power measurements for the test slot to be used for performing the alignment of the terminal.

2. The method of claim 1, wherein performing the alignment of the terminal includes one or both of performing a cross polarization alignment or a pointing alignment of the terminal.

3. The method of claim 1, wherein the set of power measurements for the test slot include a first set of power measurements for a first polarization and a second set of power measurements for a second polarization.

4. The method of claim 3, wherein the first polarization is a first linear polarization and the second polarization is a second linear polarization that is orthogonal to the first linear polarization.

5. The method of claim 3, wherein the first polarization is a first circular polarization and the second polarization is a second circular polarization.

6. The method of claim 1, wherein the set of power measurements for the test slot are extracted from the set of multi-slot power measurements based on a payload model of the satellite.

7. The method of claim 1, wherein the third signal and the fourth signal are transmitted via a management channel.

8. The method of claim 1, wherein the second signal is transmitted via a telemetry (TLM) link.

9. The method of claim 1, further comprising:
prior to the terminal transmitting the first signal to the satellite on the test slot, performing a coarse pointing alignment of the terminal.

10. The method of claim 1, further comprising:
transmitting, by the terminal, the first signal to the satellite on the test slot.

11. The method of claim 1, further comprising:
performing the alignment of the terminal using the set of power measurements for the test slot.

12. A satellite communication system comprising:
a satellite configured to:
obtain a set of multi-slot power measurements based on signals received at the satellite, the signals including a first signal transmitted by a terminal on a test slot; and
transmit a second signal including the set of multi-slot power measurements to a ground station;
a correlator configured to extract a set of power measurements for the test slot from the set of multi-slot power measurements included in the second signal; and
a gateway configured to transmit a third signal including the set of power measurements for the test slot to the satellite;
wherein the satellite is configured to transmit a fourth signal including the set of power measurements for the test slot to the terminal, the set of power measurements for the test slot to be used for performing an alignment of the terminal.

13. The satellite communication system of claim 12, wherein performing the alignment of the terminal includes one or both of performing a cross polarization alignment or a pointing alignment of the terminal.

14. The satellite communication system of claim 12, wherein the set of power measurements for the test slot include a first set of power measurements for a first polarization and a second set of power measurements for a second polarization.

15. The satellite communication system of claim 14, wherein:
the first polarization is a first linear polarization and the second polarization is a second linear polarization that is orthogonal to the first linear polarization; or
wherein the first polarization is a first circular polarization and the second polarization is a second circular polarization.

16. The satellite communication system of claim 12, wherein the set of power measurements for the test slot are extracted from the set of multi-slot power measurements based on a payload model of the satellite.

17. The satellite communication system of claim 12, wherein the third signal and the fourth signal are transmitted via a management channel.

18. One or more non-transitory computer-readable media comprising instructions that, when executed by one or more processors, cause the one or more processors to perform operations for an alignment of a terminal in a satellite communication system, the operations comprising:
sending an indicator of a test slot to the terminal;
obtaining a set of multi-slot power measurements based on signals received at a satellite, the signals including a first signal transmitted by the terminal on the test slot;
causing the satellite to transmit a second signal including the set of multi-slot power measurements to a ground station;
extracting a set of power measurements for the test slot from the set of multi-slot power measurements included in the second signal;
causing a gateway to transmit a third signal including the set of power measurements for the test slot to the satellite; and
causing the satellite to transmit a fourth signal including the set of power measurements for the test slot to the terminal, the set of power measurements for the test slot to be used for performing the alignment of the terminal.

19. The one or more non-transitory computer-readable media of claim 18, wherein performing the alignment of the terminal includes one or both of performing a cross polarization alignment or a pointing alignment of the terminal.

20. The one or more non-transitory computer-readable media of claim 18, wherein the set of power measurements for the test slot include a first set of power measurements for a first polarization and a second set of power measurements for a second polarization.
